(19) United States
(12) Patent Application Publication
(10) Pub. No.: US 2026/0057646 A1
(43) Pub. Date: Feb. 26, 2026

(54) INFORMATION PROCESSING APPARATUS, INFORMATION PROCESSING METHOD, AND STORAGE MEDIUM

(71) Applicants: KABUSHIKI KAISHA TOSHIBA, Kawasaki-shi (JP); TOSHIBA DIGITAL SOLUTIONS CORPORATION, Kawasaki-shi (JP)

(72) Inventors: Ryo KIYAMA, Koza Kanagawa (JP); Toshiki NAKASHIMA, Kawasaki Kanagawa (JP)

(73) Assignees: KABUSHIKI KAISHA TOSHIBA, Kawasaki-shi (JP); TOSHIBA DIGITAL SOLUTIONS CORPORATION, Kawasaki-shi (JP)

(21) Appl. No.: 19/307,629

(22) Filed: Aug. 22, 2025

(30) Foreign Application Priority Data
Aug. 22, 2024 (JP) 2024-140891

(51) Int. Cl. G06V 10/77; G06V 10/52; G06V 10/764; G06V 10/771; G06V 10/776; G06V 10/82

(52) U.S. Cl. CPC G06V 10/7715; G06V 10/52; G06V 10/764; G06V 10/771; G06V 10/776; G06V 10/82

(57) ABSTRACT

According to one embodiment, an information processing apparatus includes a processor. The processor is configured to acquire at least one training image including an inspection target from an image database that stores the training image, extract first features of n dimensions of the training image output from a feature extraction model by inputting the training image to the feature extraction model, select k dimensions from the n dimensions, and generate an abnormality detection model used to infer a state of the inspection target by executing training using the first features of the selected k dimensions among the first features of the n-dimensions of the training image.

### CROSS-REFERENCE TO RELATED APPLICATIONS

This application is based upon and claims the benefit of priority from Japanese Patent Application No. 2024-140891, filed Aug. 22, 2024, the entire contents of which are incorporated herein by reference.

### FIELD

Embodiments described herein relate generally to an information processing apparatus, an information processing method, and a storage medium.

### BACKGROUND

In recent years, for example, there has come to be demand to make up for shortages in labor required for inspection and to implement standardization of inspection by automatically executing appearance inspection of products manufactured in a factory or the like, acceptance inspection of components used to manufacture the products, and the like using images.

In such inspection, for example, it is conceivable to detect abnormality of inspection targets such as products or components from images using abnormality detection models (trained models) generated by executing supervised learning using normal data (for example, images containing inspection targets in normal states) and abnormality data (for example, images containing inspection targets in an abnormal states). However, in sites where the inspection is executed, defects may rarely occur in the inspection targets, and it may not be efficient to execute supervised learning of the abnormality detection models after collecting sufficient abnormality data.

On the other hand, unlike the supervised learning described above, unsupervised learning (unsupervised abnormality detection technique) can be executed with only normal data, and the cost for generating data (training data) used for the training is low, and introduction to the site is easy.

However, in the abnormality detection models generated by unsupervised learning in which training is executed with only normal data, there is a possibility of errors occurring in detection results of abnormality of the inspection targets (that is, accuracy of the abnormality detection models being low).

Therefore, a mechanism capable of efficiently training abnormality detection models based on the viewpoint described above is required.

### BRIEF DESCRIPTION OF THE DRAWINGS

FIG. 1 is a block diagram illustrating an example of a functional configuration of an information processing apparatus according to a first embodiment;

FIG. 2 is a diagram illustrating an example of a hardware configuration of the information processing apparatus;

FIG. 3 is a flowchart illustrating an example of a processing procedure of a training process;

FIG. 4 is a diagram illustrating an example of a normal image;

FIG. 5 is a diagram illustrating an example of an abnormal image;

FIG. 6 is a diagram illustrating an outline of a process of extracting a feature from a training image;

FIG. 7 is a diagram conceptually illustrating a dimensional feature;

FIG. 8 is a diagram conceptually illustrating dimension selection based on a Mahalanobis distance;

FIG. 9 is a flowchart illustrating an example of a processing procedure of an inference process;

FIG. 10 is a diagram illustrating an outline of inference process;

FIG. 11 is a block diagram illustrating an example of a functional configuration of an information processing apparatus according to a second embodiment;

FIG. 12 is a diagram illustrating an attention network used for weighting;

FIG. 13 is a diagram illustrating training of the attention network;

FIG. 14 is a block diagram illustrating an example of a functional configuration of an information processing apparatus according to a third embodiment; and

FIG. 15 is a block diagram illustrating an example of a functional configuration of an information processing apparatus according to a fourth embodiment.

### DETAILED DESCRIPTION

In general, according to one embodiment, an information processing apparatus includes a processor. The processor is configured to acquire at least one training image including an inspection target from an image database that stores the training image, extract first features of n dimensions (where n is an integer of 2 or more) of the training image output from a feature extraction model by inputting the training image to the feature extraction model, select k dimensions (where k is an integer of 1 or more and less than n) from the n dimensions, and generate an abnormality detection model used to infer a state of an inspection target by learning the first features of the selected k dimensions among the first features of n dimensions of the training image.

Various embodiments will be described with reference to the accompanying drawings.

### First Embodiment

First, a first embodiment will be described. The information processing apparatus according to the present embodiment operates as an abnormality detection apparatus configured to detect abnormality of an inspection target (inspecting a state of an inspection target) using, for example, an image containing the inspection target. As the inspection target in the present embodiment, for example, a product manufactured in a factory or the like, a component used for manufacturing the product, or the like is assumed. However, the inspection target may be an object or the like in which abnormality occurs in an appearance expressed in an image.

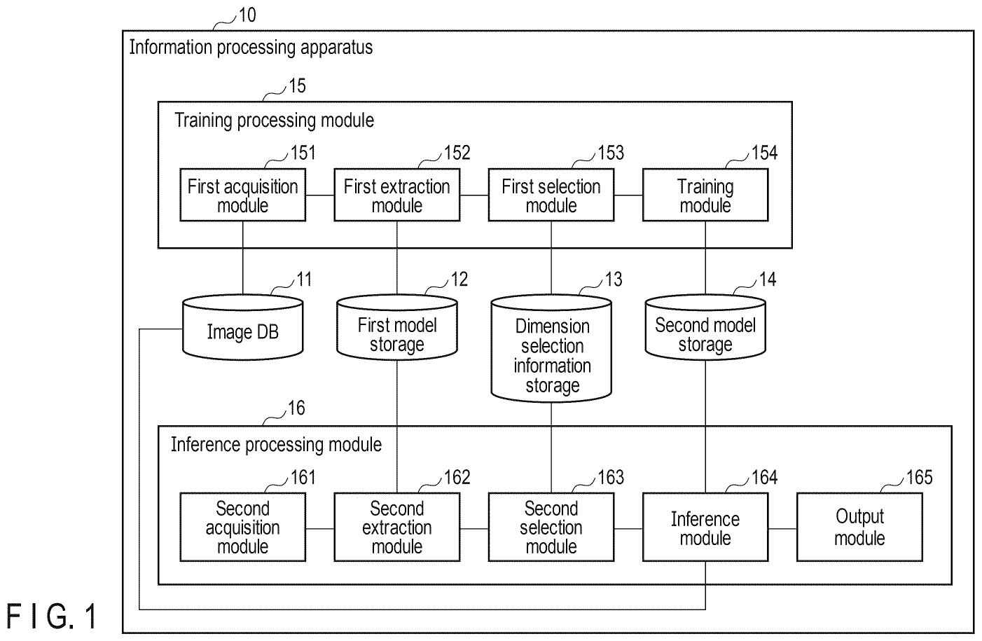

FIG. 1 is a block diagram illustrating an example of a functional configuration of an information processing apparatus according to the present embodiment. As illustrated in FIG. 1, the information processing apparatus 10 includes an image database (DB) 11, a first model storage 12, a dimension selection information storage 13, a second model storage 14, a training processing module 15, and an inference processing module 16.

The training processing module 15 includes a first acquisition module 151, a first extraction module 152, a first selection module 153, and a training module 154.

The image database 11 stores an image (hereinafter referred to as a training image) containing an inspection target used to train an abnormality detection model (inference model) to be described below. The training image stored in the image database 11 includes at least an image containing an inspection target in a normal state (hereinafter referred to as a normal image), but the training image may include an image containing an inspection target in an abnormal state (hereinafter referred to as an abnormal image).

The first acquisition module 151 acquires (reads) at least one training image from the image database 11. For example, the first acquisition module 151 may acquire the training image stored in a place indicated by a path designated by a user (an administrator who manages the information processing apparatus 10) who uses the information processing apparatus 10.

The first model storage 12 stores a feature extraction model. The first extraction module 152 extracts a feature of the training image from the training image acquired by the first acquisition module 151 using the feature extraction model stored in the first model storage 12.

Here, the feature extraction model is implemented by, for example, a neural network (NN) model such as a convolutional neural network (CNN) or a vision transformer (ViT) trained using large-scale images, and the first extraction module 152 extracts an output of an intermediate layer or an output layer of the neural network model to which the training image has been input as a feature of the training image. In the present embodiment, the first extraction module 152 extracts features of n dimensions (where n is an integer of 2 or more) from the training image. The feature extracted by the first extraction module 152 may be a feature vector or a feature map of HxWxn (where H and W are integers of 1 or more) of n dimensions.

Here, as described above, the feature is extracted using the feature extraction model implemented by the neural network model. However, the first extraction module 152 may extract a feature (hereinafter referred to as a non-NN feature) such as a color histogram or histograms of oriented gradients (HOG).

The feature extracted by the first extraction module 152 may be a combination of features extracted using a plurality of feature extraction models (neural network models) or may be a combination of features extracted using the feature extraction models and non-NN features.

Hereinafter, features of n dimensions extracted from the training image by the first extraction module 152 are referred to as features of n dimensions of the training image.

The first selection module 153 selects k dimensions (where k is an integer of 1 or more and less than n) from the n dimensions described above. Information indicating the k dimensions selected by the first selection module 153 (hereinafter referred to as dimension selection information) is stored in the dimension selection information storage 13.

The training module 154 trains the abnormality detection model using the features of k dimensions (that is, features from which the feature dimensions are excluded other than the feature dimension selected by the first selection module 153) selected by the first selection module 153 among the features of n dimensions of the training image. In other words, the training module 154 can generate the abnormality detection model by executing such training.

The abnormality detection model corresponds to a neural network model constructed to infer a state of the inspection target (for example, to detect abnormality) by learning the features of k dimensions of the training image or a distribution of the features. Specifically, the abnormality detection model includes, for example, a neural network model of a Nomalizing flow that converts a feature according to a normal distribution or an auto encoder that outputs the same feature as an input feature (that is, reproduces the feature). The abnormality detection model may be a model to which a method capable of detecting abnormality by learning a feature of an image such as one class support vector machine (SVM) is applied.

The abnormality detection model trained by the training module 154 as described above (that is, the abnormality detection model in which is trained on k features of the training image) is stored in the second model storage 14.

The inference processing module 16 includes a second acquisition module 161, a second extraction module 162, a second selection module 163, an inference module 164, and an output module 165.

The second acquisition module 161 acquires an image containing an inspection target (hereinafter referred to as an inspection image) that is a target for detecting an abnormality (that is, it is necessary to execute inspection). The inspection image acquired by the second acquisition module 161 is designated by, for example, a user using the information processing apparatus 10. Specifically, for example, when the user designates a path indicating a place where the inspection image is stored, the second acquisition module 161 can acquire (read) the inspection image stored in the place indicated by the path. The inspection image may be, for example, an image (data) captured by a camera (imaging device) or an image (data) captured by a scanner.

The second extraction module 162 extracts a feature of the inspection image from the inspection image acquired by the second acquisition module 161 using the feature extraction model stored in the first model storage 12. In this case, the second extraction module 162 extracts features of n dimensions from the inspection image. Hereinafter, features of n dimensions extracted from the inspection image by the second extraction module 162 are referred to as features of n dimensions of the inspection image.

The second selection module 163 selects k dimensions from the n dimensions described above based on the dimension selection information stored in the dimension selection information storage 13. The k dimensions selected by the second selection module 163 are the same as the k dimensions selected by the first selection module 153 described above.

The inference module 164 infers a state of the inspection target included in the inspection image (detects abnormality) using the abnormality detection model stored in the second model storage 14. The state of the inspection target is inferred based on the output of the abnormality detection model when the features of n dimensions of the inspection image are input to the abnormality detection model.

The output module 165 outputs a result (that is, an abnormality detection result of the inspection target) of the inference executed by the inference module 164. The result of the inference executed by the inference module 164 (hereinafter referred to as an inference result) includes, for example, that the inspection target is normal or abnormal.

When the state of the inspection target is inferred by the inference module 164 as described above, the inspection image is stored in the image database 11 together with the inference result. In other words, the inspection image stored in the image database 11 is used as the training image to train the abnormality detection model described above. The inspection image stored in the image database 11 together with the inference result that the inspection target is normal corresponds to a normal image. The inspection image stored in the image database 11 together with the inference result that the inspection target is abnormal corresponds to an abnormal image.

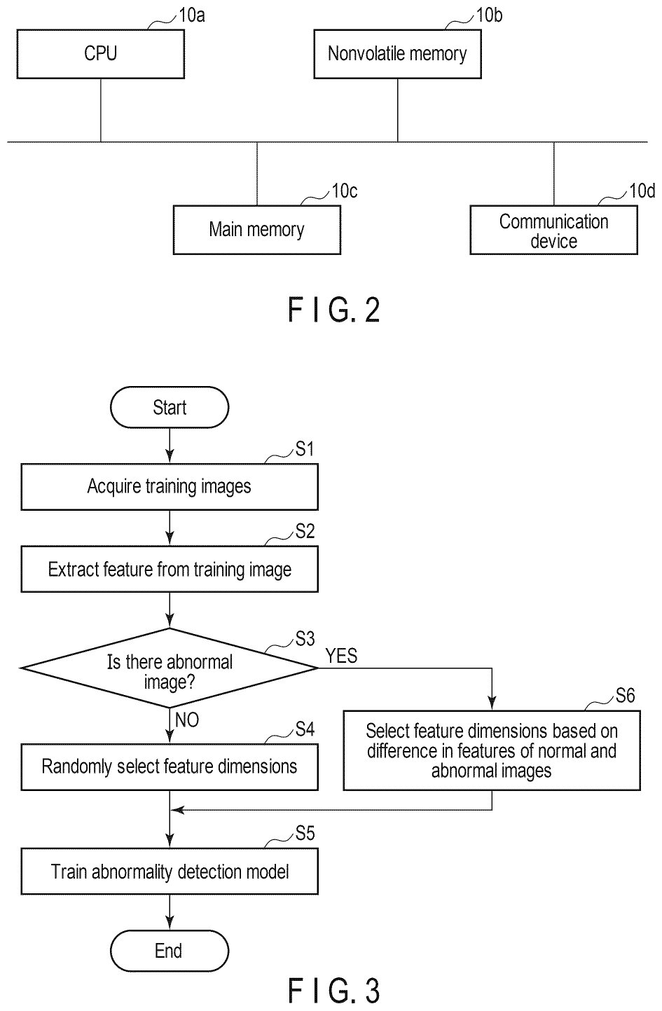

FIG. 2 illustrates an example of a hardware configuration of the information processing apparatus 10 illustrated in FIG. 1. The information processing apparatus 10 includes a CPU 10a, a nonvolatile memory 10b, a main memory 10c, and a communication device 10d.

The CPU 10a is a processor that controls operations of various components in the information processing apparatus 10. The CPU 10a may be a single processor or may include a plurality of processors. The CPU 10a executes various programs loaded from the nonvolatile memory 10b to the main memory 10c. These programs include, for example, an operating system (OS) and an application program.

The nonvolatile memory 10b is a storage medium used as an auxiliary storage device. The main memory 10c is a storage medium used as a main storage device. Although only the nonvolatile memory 10b and the main memory 10c are illustrated in FIG. 2, the information processing apparatus 10 may include other storage devices.

The communication device 10d is a device configured to execute communication with an external device (for example, a server apparatus or the like).

In the present embodiment, the image database 11, the first model storage 12, the dimension selection information storage 13, and the second model storage 14 included in the information processing apparatus 10 illustrated in FIG. 1 are implemented by, for example, the nonvolatile memory 10b, another storage device, or the like.

In the present embodiment, some or all of the training processing module 15 and the inference processing module 16 included in the information processing apparatus 10 illustrated in FIG. 1 are implemented by causing the CPU 10a (that is, a computer of the information processing apparatus 10) to execute a predetermined program, that is, by software. This program may be stored in a computer-readable storage medium to be distributed or may be downloaded to the information processing apparatus 10 via a network. Some or all of the training processing module 15 and the inference processing module 16 may be implemented by hardware such as an integrated circuit (IC), or may be implemented by a combination of software and hardware.

Although not illustrated in FIG. 2, the information processing apparatus 10 may further include an input device including a mouse and a keyboard, and a display device including a display.

Next, a processing procedure of the information processing apparatus 10 according to the present embodiment will be described. Here, a process executed by the training processing module 15 included in the information processing apparatus 10 (hereinafter referred to as a training process) and a process executed by the inference processing module 16 (hereinafter referred to as inference process) will be described.

First, an example of a processing procedure of the training process described above will be described with reference to a flowchart of FIG. 3.

Here, assuming that a plurality of training images are stored in the image database 11, in the training process, the first acquisition module 151 acquires the plurality of training images (training image group) from the image database 11 (step S1).

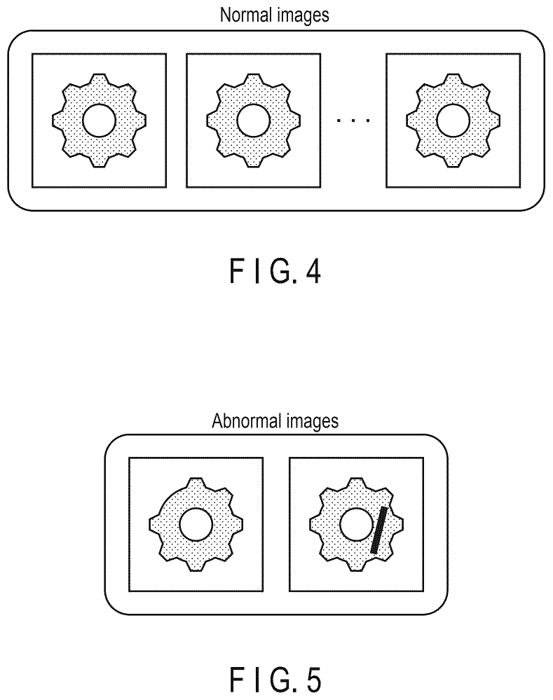

It is assumed that at least one normal image is included in the plurality of training images acquired in step S1. FIG. 4 illustrates examples of normal images. In the example illustrated in FIG. 4, for example, a normal image containing a component in a normal state as an inspection target is illustrated.

The plurality of training images acquired in step S1 may include an abnormal image or may not include the abnormal image. FIG. 5 illustrates examples of abnormal images. In the example illustrated in FIG. 5, for example, an abnormal image containing a component partially missing or a component having a flaw on the surface as an inspection target is illustrated.

It is assumed that information (for example, a label) indicating whether the training image is a normal image or an abnormal image is attached to each of the plurality of training images acquired in step S1. Specifically, a “normal” label indicating that the inspection target is normal or an “abnormal” label indicating that the inspection target is abnormal is attached to the training image.

In step S1, all of the plurality of training images stored in the image database 11 may be acquired, or some of the plurality of training images may be acquired.

Subsequently, the first extraction module 152 extracts a feature from each of the plurality of training images acquired in step S1 using the feature extraction model stored in the first model storage 12 (step S2).

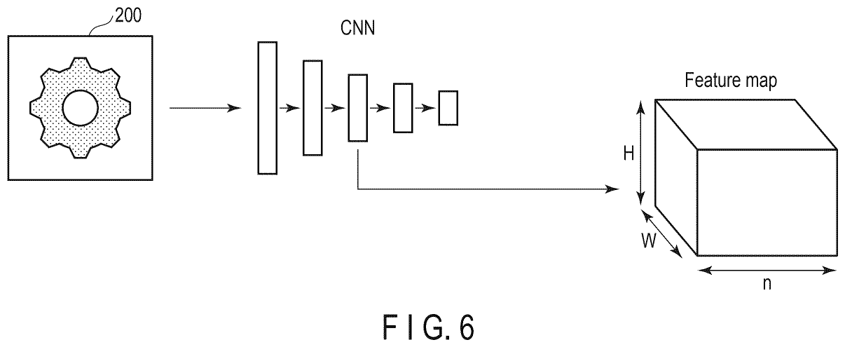

FIG. 6 illustrates an outline of a process of extracting a feature from a training image. FIG. 6 illustrates that a CNN in which has been trained on large-scale images is used as a feature extraction model, and a feature map (H×W×n) output from the intermediate layer of the CNN is extracted as a feature by inputting one training image 200 to the CNN. This feature map corresponds to features of n dimensions of the training image 200.

Here, in order to facilitate the description, an output of one intermediate layer of the CNN is used as a feature, but a feature obtained by combining outputs of a plurality of intermediate layers may be extracted.

Referring back to FIG. 3, the first selection module 153 determines whether there is an abnormal image among the plurality of training images acquired in step S1 described above (step S3). Whether the training image is an abnormal image can be determined based on a label attached to the training image.

Here, as described above, in a site where a product manufactured in a factory or the like or a component used to manufacture the product is inspected as an inspection target, a defect is less likely to occur in the inspection target, and it may be difficult to collect an abnormal image for training an abnormality detection model before an operation of the abnormality detection model. In this case, for example, in a situation where the abnormality detection model is trained before the operation of the abnormality detection model, no abnormal image is stored in the image database 11 (that is, the abnormal image as the training image cannot be collected) in some cases. In this case, in step S3, it is determined that there is no abnormal image among the plurality of training images (NO in step S3).

As described above, when there is no abnormal image among the plurality of training images, the first selection module 153 randomly selects k dimensions from the n dimensions from which the feature is extracted in step S2 (step S4). When the process of step S4 is executed, dimension selection information indicating the k dimensions selected in step S4 is stored in the dimension selection information storage 13.

Here, as described above, k dimensions are randomly selected. However, the k dimensions may be selected based on (statistics of) features of n dimensions of each of the plurality of training images extracted in step S2. Specifically, the first selection module 153 may select k dimensions with a small variation in the feature among the plurality of training images among the n dimensions.

When the process of step S4 is executed, the training module 154 trains the abnormality detection model using the k features selected in step S4 among the features of n dimensions of the training image (normal image) (step S5). As described above, assuming that the feature map (H×W×n) is extracted in step S2, the features of k dimensions correspond to the feature map (H×W×k) obtained by excluding (that is, reducing dimensions) the features of dimensions other than the k dimensions selected in step S4 from the features of the n dimensions of each training image.

In this case, the training module 154 calculates a feature distribution of the training image for each element in a spatial direction of the dimensionally reduced feature map. That is, the training module 154 calculates distributions of the features of k dimensions (each H×W feature distributions) for each of elements (H×W elements) of the feature map in the vertical and horizontal directions. The training module 154 generates an abnormality detection model by executing training using the feature distributions calculated for each training image.

Here, in the present embodiment, it is possible to generate the abnormality detection model trained with the training image (features) by executing the processes of steps S1 to S5 described above. In order to improve accuracy (abnormality detection accuracy) of the abnormality detection model after starting the operation of the abnormality detection model generated in this manner, it is preferable to repeatedly execute the process (training process) illustrated in FIG. 3 even after starting the operation of the abnormality detection model.

Here, the case where it is determined in step S3 that there is no abnormal image among the plurality of training images has been described. However, when an inference process to be described below is executed, for example, an inspection image in which the inspection target has been inferred to be abnormal (an abnormal image containing an inspection target in which an abnormality has been detected) is stored in the image database 11. Therefore, for example, when the training process is repeatedly executed, there is a possibility of an abnormal image being stored in the image database 11.

When the training process is executed in a state where the abnormal image is stored in the image database 11 in this manner, it is determined in step S3 that there is an abnormal image among the plurality of training images (YES in step S3). In this case, the first selection module 153 selects k dimensions from the n dimensions based on the features of the n dimensions of each of the plurality of training images (the normal and abnormal images) extracted in step S2 (step S6). In step S6, for example, differences in the features between the normal and abnormal images are calculated in each of n dimensions, and k dimensions with large calculated differences are selected as feature dimensions used for abnormality detection.

Hereinafter, the process of step S6 will be specifically described. Here, some of the normal images included in the plurality of training images described above are referred to as first normal images, and the other of the normal images are referred to as second normal images. In this case, the first selection module 153 compares, for example, a difference (hereinafter referred to as a first difference) between the feature of the first normal image and the feature of the second normal image and a difference (hereinafter referred to as a second difference) between the feature of the first normal image and the feature of the abnormal image in each of the n dimensions, and selects k dimensions in which the second difference is greater than the first difference.

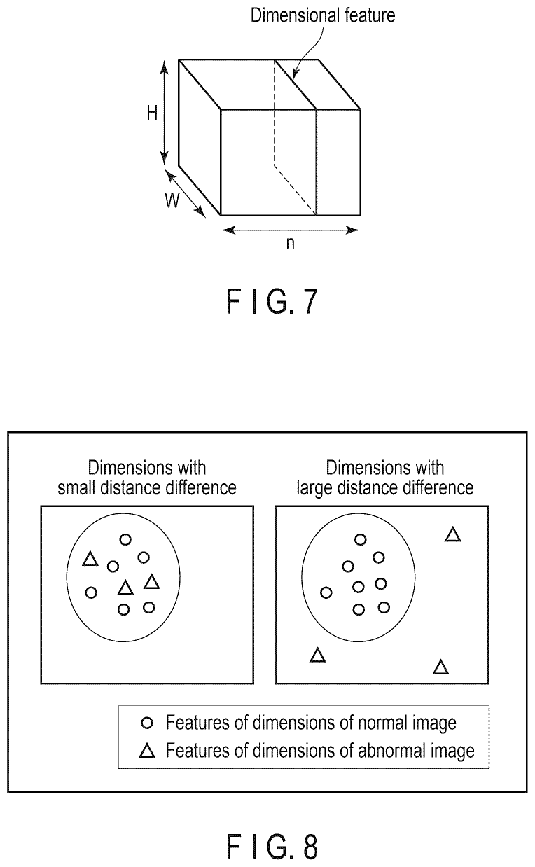

Specifically, for example, it is assumed that features of n dimensions of the training images (the first and second normal images and the abnormal images) are a feature map of H×W×n, and a feature of one dimension among the n dimensions (one feature vector including a feature of an element of H×W in one dimension of the feature map) is set as a dimensional feature. FIG. 7 conceptually illustrates the dimensional feature.

In this case, as the first difference, for example, an average value (hereinafter referred to as a first Mahalanobis distance) of the Mahalanobis distances between one feature distribution in H×W dimensions calculated from one dimensional feature of the first normal image and the dimensional feature of the second normal image is calculated for each dimension. Similarly, as the second difference, an average value (hereinafter referred to as a second Mahalanobis distance) of the Mahalanobis distances between the feature distribution of H×W dimensions calculated from one dimensional feature of the first normal image and the dimensional features of the abnormal image is calculated for each dimension. The Mahalanobis distance corresponds to a distance calculated in consideration of a correlation of data.

In this case, the first selection module 153 calculates an absolute value of the difference between the first and second Mahalanobis distances for each dimension as the difference in the feature between the normal and abnormal images described above, and selects k dimensions with a large absolute value. FIG. 8 conceptually illustrates dimension selection based on the first and second Mahalanobis distances described above. In a dimension having a large absolute value (that is, the distance difference) of the difference between the first and second Mahalanobis distances, it is easier to distinguish the normal and abnormal images based on the feature than in a dimension with a small distance difference. Therefore, in the present embodiment, a dimension with a large distance difference is selected for training and inference.

Here, as described above, k dimensions are selected. However, the k may be a constant or may be dynamically determined. When k is a constant, k dimensions may be selected in descending order of the absolute value of the difference between the first and second Mahalanobis distances. When k is dynamically determined, all the dimensions in which the absolute value of the difference between the first and second Mahalanobis distances is equal to or greater than a threshold may be selected.

Here, as described above, the Mahalanobis distance is used when the first and second differences are calculated. However, the first and second differences may be calculated using a Euclidean distance or the like in which a correlation of data is not considered.

Furthermore, the difference in the features between the normal and abnormal images may be calculated by another method. Specifically, for example, the features of the normal and abnormal images may be clustered in each dimension, and a distance between the cluster to which the features of the normal image belong and the cluster to which the features of the abnormal image belong may be used as the difference between the features of the normal and abnormal images.

When the process of step S6 is executed, dimension selection information indicating the k dimensions selected in step S6 is stored in the dimension selection information storage 13. When the training process is already executed and other dimension selection information is already stored in the dimension selection information storage 13, the dimension selection information indicating the k dimensions selected in step S6 is overwritten with the already stored other dimension selection information.

Subsequently, the training module 154 trains the abnormality detection model using the features of k dimensions selected in step S6 among the features of n dimensions of the training image (step S5). Since the process of step S5 is as described above, detailed description thereof is omitted here. It is assumed that there is an abnormal image in the training image when the process of step S6 described above is executed. However, the training image used to train the abnormality detection model is a normal image.

According to the process (training process) illustrated in FIG. 3 described above, an abnormality detection model can be generated by executing training using features of k dimensions among features of n dimensions extracted from training images including one or more normal images and 0 or more abnormal images acquired from the image database 11. Further, according to the processes illustrated in FIG. 3, for example, it is possible to implement an operation of executing training using only the normal image before the operation of the abnormality detection model and updating the abnormality detection model using the abnormal image after the operation of the abnormality detection model.

In the training process described above, for example, some of the plurality of training images acquired in step S1 may be used for dimension selection, and the other of the plurality of training images may be used to train the abnormality detection model. In other words, the training images used for the dimension selection and the training of the abnormality detection model may be the same or may be at least partially different.

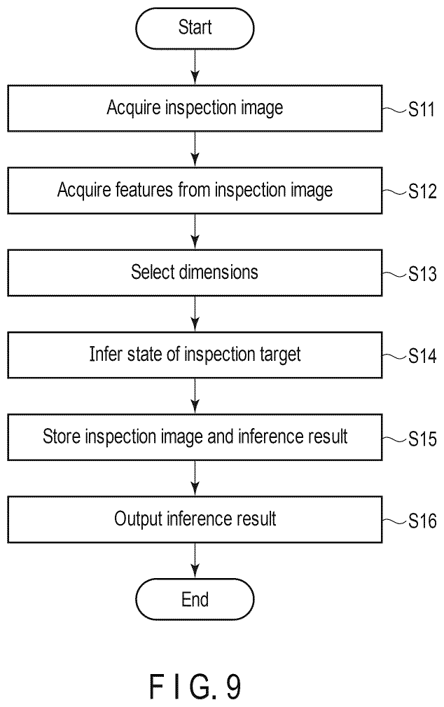

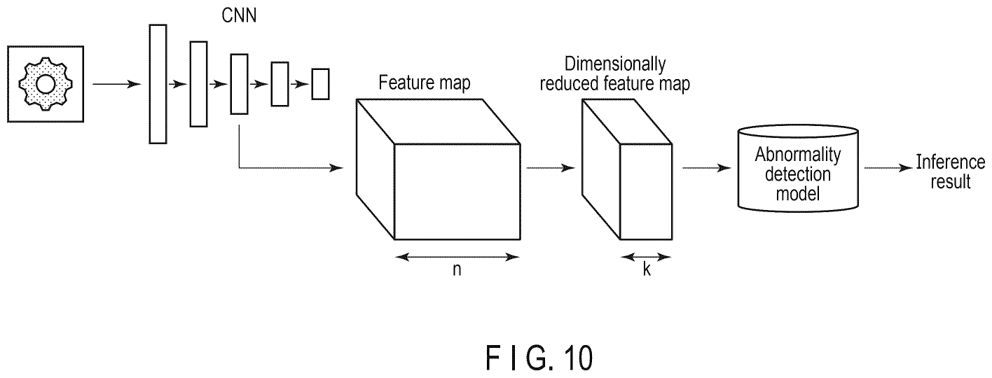

Next, an example of a processing procedure of the inference process described above will be described with reference to a flowchart of FIG. 9. FIG. 10 illustrates an outline of the inference process illustrated in FIG. 9.

In the inference process, the second acquisition module 161 acquires the inspection image (the image of the abnormality detection target) containing the inspection target (step S11). To facilitate description, it is assumed that one inspection image is acquired in step S11, but a plurality of inspection images may be acquired. When the plurality of inspection images are acquired in step S11, the following processes of steps S12 to S16 may be executed for each of the inspection images.

Subsequently, the second extraction module 162 extracts the features from the inspection image acquired in step S11 using the feature extraction model (for example, CNN) stored in the first model storage 12 (step S12). In this case, the inspection image is input to the feature extraction model, and the features output from the feature extraction model (intermediate layer) are extracted. The features extracted from the inspection image in step S12 are features of n dimensions (for example, a feature map of H×W×n). The process of step S12 is similar to the process of step S2 illustrated in FIG. 3 described above, and thus detailed description thereof is omitted here.

When the process of step S12 is executed, the second selection module 163 acquires the dimension selection information stored in the dimension selection information storage 13. Based on the acquired dimension selection information (that is, the k dimensions selected by the first selection module 153 in the training process described above), the second selection module 163 selects k dimensions from the n dimensions from which the features are extracted in step S12 (step S13).

When the process of step S13 is executed, the inference module 164 acquires the features of k dimensions selected in step S13 among the features of n dimensions of the inspection image extracted in step S12. The features of k dimensions correspond to a feature map (H×W×k) in which features other than the features of k dimensions selected in step S13 are excluded (that is, dimensions are reduced) from the features of n dimensions of the inspection image.

The inference module 164 infers a state of the inspection target included in the inspection image by inputting the acquired features of the k dimensions of the inspection image to the abnormality detection model stored in the second model storage 14 (step S14). The process of step S14 corresponds to a process of detecting abnormality of the inspection target included in the inspection image.

Here, assuming that the features of k dimensions of the inspection image are a feature map of H×W×k, in step S14, the abnormality detection model calculates the Mahalanobis distance between the features of the inspection image and the feature distribution of the normal image learned by the abnormality detection model in the training process for each element (each of the H×W elements) in the spatial direction of the feature map. The inference module 164 sets a maximum value of the Mahalanobis distance of each element calculated in this manner as an abnormality score indicating the degree of abnormality of the inspection target included in the inspection image.

The training and inference method (abnormality detection method) described in the present embodiment are exemplary, and other methods may be applied in the present embodiment. Specifically, for example, a method may be applied in which the feature distribution of the normal image is not calculated for each element (H×W elements) in the vertical and horizontal directions of the feature map during training, but the feature itself of the normal image is held for each element, a distance between the features of the inspection and normal images are calculated during inference, and the larger the distance between the features of the inspection image and the features of the normal image is, the higher the abnormality score is. In the present embodiment, a method using one class SVM may be applied.

In the inference module 164, a threshold for detecting abnormality of the inspection target (a threshold set as a boundary between normality and abnormality) is held in advance. The inference module 164 can detect the abnormality of the inspection target by comparing the abnormality score with the threshold. Specifically, the inference module 164 determines whether the abnormality score is equal to or greater than the threshold, and does not detect abnormality of the inspection target when the abnormality score is less than the threshold, and detects abnormality of the inspection target when the abnormality score is equal to or greater than the threshold.

Here, in the above description, it is assumed that a maximum value of the Mahalanobis distance of each element described above is the abnormality score. However, the abnormality score may not be necessarily the maximum value of the Mahalanobis distance. Specifically, the Mahalanobis distance is calculated for each element in the spatial direction. According to the Mahalanobis distance, a region (for example, a scratched portion of the inspection target or the like) of the inspection image with the high degree of abnormality can be determined. Therefore, a statistic such as an average value of the Mahalanobis distances calculated for each element corresponding to the region may be used as the abnormality score. In other words, the abnormality score may be, for example, a value calculated from the Mahalanobis distance.

The abnormality score may be any score as long as the abnormality score is appropriate for a predetermined abnormality detection method. For example, the abnormality detection model may be constructed to output the above-described abnormality score or may be constructed to output a state (normality or abnormality) of the inspection target.

When the process of step S14 is executed, the inspection image and the inference result in step S14 are stored in the image database 11 (step S15). The inference result includes the inspection target that is normal or the inspection target that is abnormal. However, the inspection image is stored in the image database 11 with a label according to the inference result being attached and is used in the training process to be executed below.

Although it is assumed here that the inspection image is stored in the image database 11 whenever the inference process is executed, it is not necessary to store all the inspection images in the image database 11. Specifically, for example, only an inspection image in which an abnormality is detected (that is, the abnormal image) may be stored in the image database 11, or only an inspection image with a high abnormality score may be stored in the image database 11. Only some of the inspection images in which no abnormality is detected (that is, normal images) may be stored in the image database 11, rather than storing all the inspection images. According to such a configuration, an abnormal image that is relatively difficult to collect can be preferentially stored in the image database 11, and the number of images (the number of records) stored in the image database 11 can be curbed from becoming enormous.

When the process of step S15 is executed, the output module 165 outputs the inference result described above (step S16). The inference result may be output to the communication device 10d to be transmitted to, for example, a server apparatus or the like outside of the information processing apparatus 10, or may be output to a display device (display) to be presented to the user.

The inference result output in step S16 may include at least the inspection target that is normal or abnormal. However, for example, the abnormality score described above may be included, an abnormality score map in which the Mahalanobis distance calculated for each element in the spatial direction of the feature map is assigned to the element as an abnormality score may be included, or a combination thereof may be included. Further, in step S16, the inference result described above may be processed and output.

According to the process (inference process) illustrated in FIG. 9 described above, the state of the inspection target included in the inspection image can be inferred using the abnormality detection model generated by executing the training process.

In FIG. 9, as described above, the process of step S16 is executed after the process of step S15 is executed. However, an order of the processes of steps S15 and S16 may be switched, or the processes of steps S15 and S16 may be executed in parallel.

As described above, the information processing apparatus 10 according to the present embodiment acquires a training image from the image database 11, extracts features (first features) of n dimensions of the training image output from the feature extraction model by inputting the acquired training image to the feature extraction model, selects k dimensions from the n dimensions, and executes training using the features of the selected k dimensions from the features of the n dimensions of the training image. Thus, an abnormality detection model used to infer the state of the inspection target (detect abnormality) is generated.

In the above-described configuration, the information processing apparatus 10 according to the present embodiment can train the abnormality detection model regardless of whether an abnormal image is included in the training image. Therefore, it is possible to implement efficient training of the abnormality detection model.

For example, when there is no abnormal image in the training images acquired from the image database 11, k dimensions may be randomly selected from the n dimensions, or k dimensions with a small variation in the feature between the training images may be selected from the n dimensions.

In such a configuration, for example, even when the abnormal image is not collected before an operation of the abnormality detection model, the abnormality detection model can be generated using only the normal image and unknown abnormality can be detected.

For example, when there is an abnormal image in the training image acquired from the image database 11, k dimensions in which a difference (second difference) between features of some of the normal images and features of the abnormal images is greater than a difference (first difference) between features of some of the normal images (first normal image) s and a feature of the other of the normal images (second normal images) are selected among the n dimensions.

In such a configuration, for example, when an abnormal image is collected by operating the abnormality detection model, the abnormality detection model is updated (retrained) using the abnormal image, and thus accuracy of the abnormality detection model (accuracy of detection of the abnormality of the inspection target) can be improved without changing the method of detecting the abnormality of the inspection target.

As described above, in the present embodiment, flexible training of the abnormality detection model can be implemented according to whether there is an abnormal image in the training image.

According to the present embodiment, as described above, in the configuration in which the abnormality detection model is trained using the features of k dimensions selected from the n dimensions, the accuracy of the abnormality detection model can be improved compared with the configuration in which the abnormality detection model is trained simply using the feature extracted from the training image.

The information processing apparatus 10 according to the present embodiment acquires an inspection image, extracts features of n dimensions (second features) of the inspection image output from the feature extraction model by inputting the acquired inspection image to the feature extraction model, and infers a state of the inspection target by inputting the features of the selected k dimensions among the features of n dimensions of the inspection image to an abnormality detection model.

According to the present embodiment, in such a configuration, the abnormality of the inspection target with high accuracy can be detected using the trained abnormality detection model as described above.

Further, according to the present embodiment, the inspection image on which the inference is executed is stored in the image database 11 together with the inference result. Accordingly, an abnormal image can be collected while operating the abnormality detection model and the retraining (updating) of the abnormality detection model can be implemented using the abnormal image as a training image.

In the present embodiment, as described above, the information processing apparatus 10 includes the image database 11, the first model storage 12, the dimension selection information storage 13, the second model storage 14, the training processing module 15, and the inference processing module 16. However, the information processing apparatus 10 may include only some of the modules 11 to 16. Specifically, the information processing apparatus 10 according to the present embodiment may be configured such that, for example, the inference processing module 16 is omitted and only the training process is executed. The information processing apparatus 10 according to the present embodiment may be configured such that at least some of the image database 11, the first model storage 12, the dimension selection information storage 13, and the second model storage 14 are disposed outside.

In the present embodiment, as described above, the information processing apparatus 10 is one apparatus. However, the information processing apparatus 10 may be realized as an information processing system or the like implemented by a plurality of apparatuses. Specifically, the present embodiment may be, for example, an information processing system including a training processing apparatus that executes a process corresponding to the training processing module 15 included in the information processing apparatus 10 and an inference processing apparatus (abnormality detection apparatus) that executes a process corresponding to the inference processing module 16 included in the information processing apparatus 10.

### Second Embodiment

Next, a second embodiment will be described. In the present embodiment, detailed description of portions similar to those of the first embodiment described above is omitted, and portions different from those of the first embodiment will be mainly described.

The present embodiment is different from the first embodiment described above in that weighting is executed in a dimension direction of features of k dimensions, and abnormality detection is executed focusing on a feature dimension having a difference between normal and abnormal images.

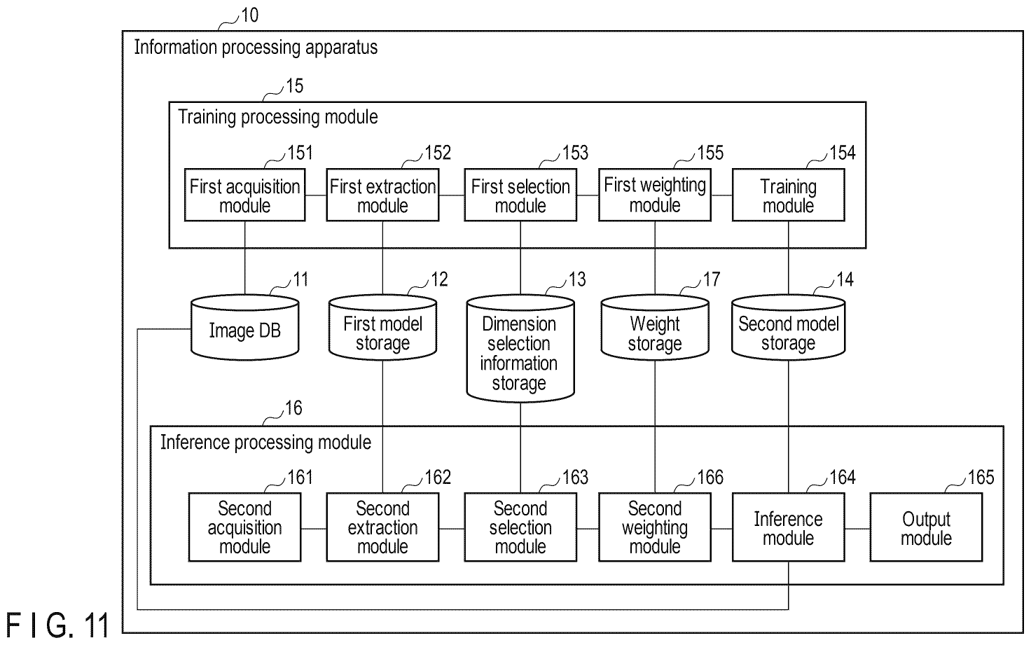

FIG. 11 is a block diagram illustrating an example of a functional configuration of the information processing apparatus according to the present embodiment. In FIG. 11, the same portions as those in FIG. 1 described above are denoted by the same reference numerals, and detailed description thereof is omitted.

As illustrated in FIG. 11, the information processing apparatus 10 according to the present embodiment includes a weight storage 17. The training processing module 15 included in the information processing apparatus 10 includes a first weighting module 155. Furthermore, the inference processing module 16 included in the information processing apparatus 10 includes a second weighting module 166.

The first weighting module 155 determines a weight of each of the k dimensions based on the features of the k dimensions (features after dimension reduction) selected by the first selection module 153 among the features of the n dimensions of the training image extracted by the first extraction module 152, and executes weighting on the features of the k dimensions using the determined weight. The weighting is executed by the first weighting module 155 when there is an abnormal image in the training image.

Specifically, when k dimensions are selected using the absolute value of the difference between the first and second Mahalanobis distances described in the first embodiment described above, magnitude of the absolute value of the difference between the first and second Mahalanobis distances calculated in each of the k dimensions is determined as a weight, and the feature of the dimension is multiplied by the weight determined for the dimension.

In this case, the training module 154 trains the abnormality detection model using the features of k dimensions weighted by the first weighting module 155 as described above.

For example, an attention network (model) for dynamically specifying data to be noted may be prepared, and the features of k dimensions may be input to the attention network to implement weighting (weighting in the dimension direction) on the features of the k dimensions.

Here, as described above, the weighting is executed when there is an abnormal image in the training image. However, when there is no abnormal image in the training image, the weighting may not be executed, or uniform weighting may be executed on all the features of k dimensions.

The weighting method described here is exemplary, and weighting may be executed by another method.

The weight (that is, the weight for each dimension) determined for the k dimensions as described above is stored in the weight storage 17.

The second weighting module 166 executes weighting on the features of k dimensions (features after dimension reduction) selected by the second selection module 163 among the features of n dimensions of the inspection image extracted by the second extraction module 162 based on the weight for each dimension stored in the weight storage 17. In this case, the inference module 164 infers a state of the inspection target included in the inspection image (detects abnormality) by inputting the features of k dimensions weighted by the second weighting module 166 to the abnormality detection model as described above.

Although the functional configuration of the information processing apparatus 10 according to the present embodiment has been described here, the hardware configuration of the information processing apparatus 10 is similar to that of the first embodiment described above, and thus detailed description thereof is omitted. In the present embodiment, the weight storage 17 illustrated in FIG. 11 is implemented by, for example, the nonvolatile memory 10b or another storage device illustrated in FIG. 2 described above.

Hereinafter, a training process and an inference process executed in the information processing apparatus 10 according to the present embodiment will be briefly described with specific examples.

First, the training process will be described. The first acquisition module 151 included in the training processing module 15 acquires a training image similarly to the first embodiment described above. Here, it is assumed that there are both normal and abnormal images in the training image. Subsequently, the first extraction module 152 extracts a feature map (H×W×n) output from the intermediate layer of the CNN using the CNN trained with large-scale images as a feature extraction model. Subsequently, the first selection module 153 selects a dimension having a large difference in feature between the normal and abnormal images as a dimension (feature dimension) to be used for abnormality detection. Accordingly, a feature map (dimensionally reduced feature map of H×W×k) in which dimensions other than the selected k dimensions are excluded is obtained.

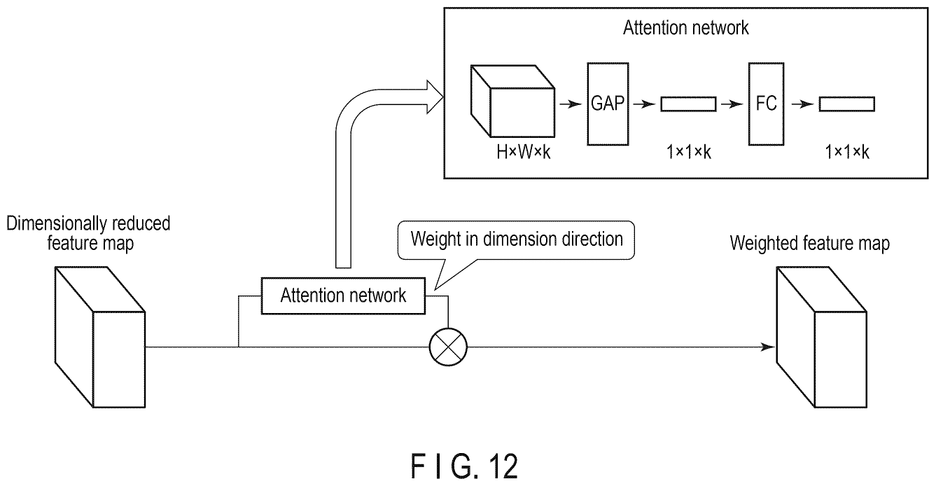

Here, as illustrated in FIG. 12, the first weighting module 155 outputs a feature map weighted by multiplying a weight obtained by inputting the dimensionally reduced feature map (H×W×k) to the attention network by the feature map. The attention network includes a global averaging pooling (GAP) layer and a fully connected (FC) layer, but may include a combination of any layers other than these layers.

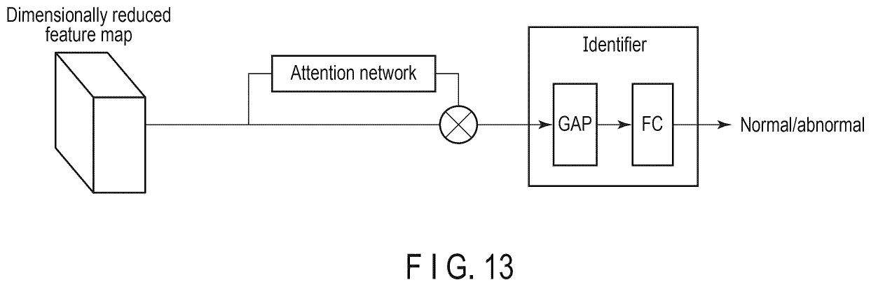

It is assumed that the attention network is prepared (generated) by executing training in advance. As illustrated in FIG. 13, training for the attention network is executed such that normality and abnormality are identified in a network in which an identifier including a GAP layer and an FC layer is connected to a feature map obtained by multiplying the weight obtained by the attention network to which the dimensionally reduced feature map has been input. In other words, the attention network learns to output a weight for each dimension in which normality and abnormality can be correctly identified in the identifier. Accordingly, it is possible to obtain the attention network trained on the weight of the dimension in which it is easy to distinguish normality and abnormality.

The training module 154 trains the abnormality detection model similarly to the first embodiment using the feature map of the training image (normal image) weighted by the first weighting module 155.

Next, an inference process will be described. In the inference process according to the present embodiment, after k dimensions are selected (a dimensionally reduced feature map is obtained) as described in the first embodiment described above, a weighted feature map is obtained by multiplying the feature maps by the weight (the weight stored in the weight storage 17) used in the training process. The weighted feature map may be obtained by multiplying the dimensionally reduced feature map by the weight obtained by inputting the dimensionally reduced feature map to the attention network trained as described above. In the present embodiment, by inputting the feature map obtained by weighting in this manner to the abnormality detection model, the state of the inspection target is inferred (inference result is obtained).

As described above, the information processing apparatus 10 according to the present embodiment determines the weight of each of the k dimensions based on the features of the k dimensions of the training image and executes weighting on the features of the k dimensions of the training image using the determined weight. The weight may be determined based on the first and second Mahalanobis distances (first and second differences) described in the first embodiment described above, or may be determined using an attention network prepared in advance (that is, inputting the features of k dimensions of the normal image to the attention network). It is assumed that the attention network is generated by executing training to output a weight for each dimension in which normality and abnormality can be identified.

According to the present embodiment, in the above-described configuration, it is possible to implement abnormality detection focusing on a feature dimension with a difference in feature between normal and abnormal images. Therefore, it is possible to improve the accuracy of detection of an abnormality of an inspection target.

### Third Embodiment

Next, a third embodiment will be described. In the present embodiment, detailed description of portions similar to those of the second embodiment described above is omitted, and portions different from those of the second embodiment will be mainly described.

The present embodiment is different from the second embodiment described above in that dimensions having small weights are excluded (dimension reduction is executed) after weighting the features in the dimension direction.

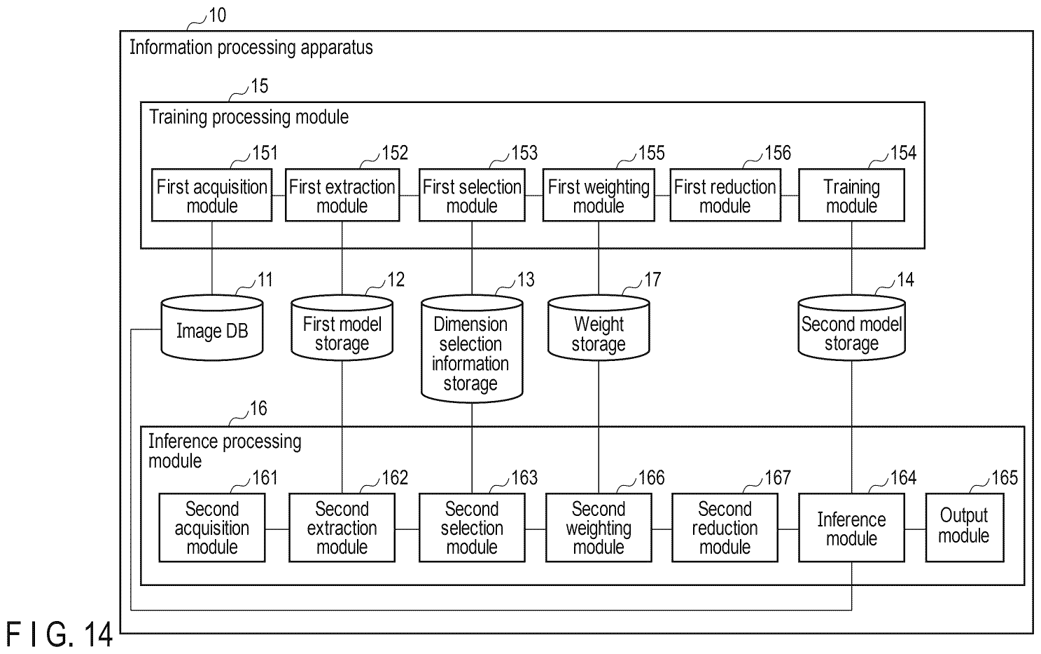

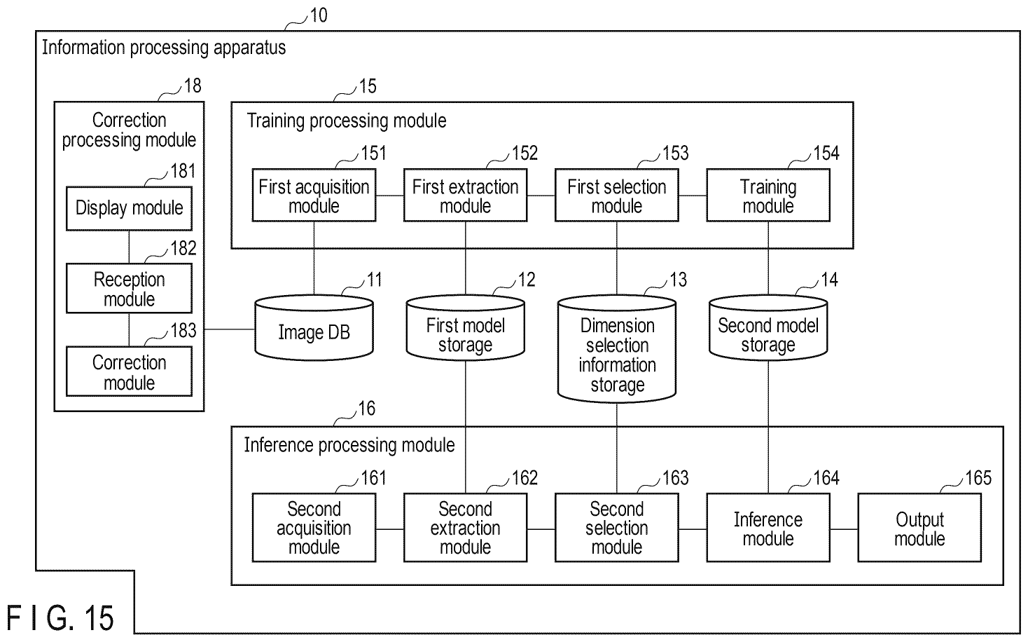

FIG. 14 is a block diagram illustrating an example of a functional configuration of the information processing apparatus according to the present embodiment. In FIG. 14, the same portions as those in FIG. 11 described above are denoted by the same reference numerals, and detailed description thereof is omitted.

As illustrated in FIG. 14, the training processing module 15 included in the information processing apparatus 10 according to the present embodiment includes a first reduction module 156. The inference processing module 16 included in the information processing apparatus 10 according to the present embodiment includes a second reduction module 167.

Here, as described in the second embodiment described above, the first weighting module 155 determines a weight of each of the k dimensions based on the features of the k dimensions of the training image (normal image), but the first reduction module 156 reduces (excludes) a dimension with a small weight from the features of the k dimensions.

In this case, the training module 154 trains the abnormality detection model using the dimensional feature (weighted feature) not reduced by the first reduction module 156.

The second reduction module 167 reduces (excludes) a dimension with a small weight from the features of the k dimensions for which the weight is determined by the second weighting module 166.

In this case, the inference module 164 inputs the feature (weighted feature) of the dimension not reduced by the second reduction module 167 to the abnormality detection model, thereby inferring the state of the inspection target included in the inspection image.

The training process and the inference process executed in the information processing apparatus 10 according to the present embodiment are similar to those of the second embodiment described above except that a dimension with a small weight is excluded when training and inference are executed as described above. Therefore, detailed description thereof is omitted here.

As described above, the information processing apparatus 10 according to the present embodiment reduces a dimension with a small weight from the features of the k dimensions of the training image, and generates the abnormality detection model by training the features of the dimensions that are not reduced. The information processing apparatus 10 according to the present embodiment executes inference by reducing a dimension with a small weight from the features of the k dimensions of the inspection image and inputting the features of the dimensions not reduced to the abnormality detection model.

According to the present embodiment, in such a configuration, since the number of feature dimensions used for abnormality detection is reduced further than in the second embodiment described above, a processing time for the abnormality detection can be shortened.

### Fourth Embodiment

Next, a fourth embodiment will be described. In the present embodiment, detailed description of portions similar to those of the first embodiment described above is omitted, and portions different from those of the first embodiment will be mainly described.

The present embodiment is different from the first embodiment described above in that the present embodiment has a function of correcting a label (inference result) attached to an inspection image stored in an image database as a training image.

FIG. 15 is a block diagram illustrating an example of a functional configuration of the information processing apparatus according to the present embodiment. In FIG. 15, the same portions as those in FIG. 1 described above are denoted by the same reference numerals, and detailed description thereof is omitted.

As illustrated in FIG. 15, the information processing apparatus 10 according to the present embodiment includes a correction processing module 18. The correction processing module 18 includes a display module 181, a reception module 182, and a correction module 183.

The display module 181 displays the inspection image stored in the image database 11 and a label (an inference result for the inspection target included in the inspection image) attached to the inspection image on, for example, a display device or the like.

Here, the reception module 182 provides a function corresponding to a graphical user interface (GUI) together with the display module 181, and receives a user operation (input) on the label displayed by the display module 181. Here, it is assumed that the user executes an operation of instructing an appropriate label to be attached to the inspection image by visually recognizing the inspection target included in the inspection image displayed by the display module 181.

The correction module 183 corrects the label attached to the inspection image stored in the image database 11 in response to the user operation received by the reception module 182. Specifically, for example, when the label attached to the inspection image is “normal” and the user operation of instructing that an appropriate label to be attached to the inspection image is “abnormal” is received, the correction module 183 corrects the label attached to the inspection image from “normality” to “abnormality”. For example, when the label attached to the inspection image is “abnormal” and the user operation instructing that an appropriate label to be attached to the inspection image is “normal” is received, the correction module 183 corrects the label attached to the inspection image from “abnormality” to “normality”.

The user may execute an operation of instructing whether the label attached to the inspection image is correct instead of an operation of instructing an appropriate label to be attached to the inspection image.

Here, the functional configuration of the information processing apparatus 10 according to the present embodiment has been described. However, since the hardware configuration of the information processing apparatus 10 is similar to that of the first embodiment described above, detailed description thereof is omitted. In the present embodiment, a part or all of the correction processing module 18 illustrated in FIG. 15 may be implemented by causing the CPU 10a illustrated in FIG. 2 described above to execute a predetermined program, that is, may be implemented by software, may be implemented by hardware, or may be implemented by a combination of software and hardware.

Since the training process and the inference process executed in the information processing apparatus 10 according to the present embodiment are similar to those of the first embodiment described above, detailed description thereof is omitted here. In the present embodiment, after the inspection image is stored in the image database 11 by executing the inference process described above and before the training process using the inspection image as the training image is executed, the process by the correction processing module 18 described above (a process of correcting a label attached to the inspection image) may be executed.

As described above, the information processing apparatus 10 according to the present embodiment displays the inspection image and the label (inference result), receives the user operation on the label, and corrects the label in response to the received user operation. According to the present embodiment, in such a configuration, it is possible to prevent dimension selection and abnormality detection model training from being executed using an erroneous inference result (a result of erroneous determination in abnormality detection).

According to at least one of the embodiments described above, it is possible to provide an information processing apparatus, an information processing method, and a program capable of implementing efficient training of an abnormality detection model.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a processor configured to:
acquire at least one training image including an inspection target from an image database that stores the training image;
extract first features of n dimensions (where n is an integer of 2 or more) of the training image output from a feature extraction model by inputting the training image to the feature extraction model;
select k dimensions (where k is an integer of 1 or more and less than n) from the n dimensions; and
generate an abnormality detection model used to infer a state of the inspection target by executing training using the first features of the selected k dimensions among the first features of the n-dimensions of the training image.

2. The information processing apparatus according to claim 1, wherein
the processor is configured to:
acquire an inspection image including the inspection target;
extract second features of the n dimensions of the inspection image output from the feature extraction model by inputting the inspection image to the feature extraction model; and
infer a state of the inspection target by inputting the second features of the selected k dimensions among the second features of the n dimensions of the inspection image to the abnormality detection model.

3. The information processing apparatus according to claim 2, wherein
the inspection image is stored as the training image in the image database together with an inference result.

4. The information processing apparatus according to claim 2, wherein
when there is at least one normal image including the inspection target in a normal state and there is no abnormal image including the inspection target in an abnormal state in the acquired training image, the processor is configured to randomly select k dimensions from the n dimensions.

5. The information processing apparatus according to claim 2, wherein
when there is a normal image including the inspection target in a normal state and there is no abnormal image including the inspection target in an abnormal state in the acquired training image, the processor is configured to select k dimensions with a small variation in the first feature between the training images among the n dimensions.

6. The information processing apparatus according to claim 2, wherein
when there are first and second normal images including the inspection target in a normal state and an abnormal image including the inspection target in an abnormal state in the acquired training image, the processor is configured to select, from among the n dimensions, k dimensions in which a second difference between the first feature of the first normal image and the first feature of the abnormal image is greater than a first difference between the first feature of the first normal image and the first feature of the second normal image.

7. The information processing apparatus according to claim 6, wherein
the processor is configured to:
determine a weight of each of the k dimensions based on the first features of the k dimensions of the training image, and execute weighting on each of the first features of the k dimensions of the training image using the determined weight;
execute weighting on the second features of k dimensions of the inspection image using the weight;
generate the abnormality detection model by executing training using the weighted first features of the k dimensions; and
execute the inference by inputting the weighted second features of the k dimensions to the abnormality detection model.

8. The information processing apparatus according to claim 7, wherein
the weight is determined based on the first and second differences.

9. The information processing apparatus according to claim 7, wherein
the weight is determined by inputting the first features of the k dimensions of the training image to an attention network prepared in advance.

10. The information processing apparatus according to claim 9, wherein
the attention network is generated by executing training for outputting a weight for each dimension in which normality and abnormality are identifiable.

11. The information processing apparatus according to claim 7, wherein
the processor is configured to:
reduce a dimension in which the determined weight is small, from the first features of the k dimensions of the training image;
reduce a dimension in which the determined weight is small, from the first features of the k dimensions of the inspection image;
generate the abnormality detection model by executing training using the first features of the dimensions that are not reduced; and
execute the inference by inputting the second features of the dimensions that are not reduced to the abnormality detection model.

12. The information processing apparatus according to claim 3, wherein
the processor is configured to:
display the inspection image and the inference result;
receive a user operation on the inference result; and
correct the inference result in response to the user operation.

13. An information processing method executed by an information processing apparatus, the method comprising:
acquiring at least one training image including an inspection target from an image database that stores the training image;
extracting first features of n dimensions (where n is an integer of 2 or more) of the training image output from a feature extraction model by inputting the training image to the feature extraction model;
selecting k dimensions (where k is an integer of 1 or more and less than n) from the n dimensions; and
generating an abnormality detection model used to infer a state of the inspection target by executing training using the first features of the selected k dimensions among the first features of the n dimensions of the training image.

14. A non-transitory computer-readable storage medium having stored thereon a program which is executed by a computer of an information apparatus, the program comprising instructions capable of causing the computer to execute functions of:
acquiring at least one training image including an inspection target from an image database that stores the training image;
extracting first features of n dimensions (where n is an integer of 2 or more) of the training image output from a feature extraction model by inputting the training image to the feature extraction model;
selecting k dimensions (where k is an integer of 1 or more and less than n) from the n dimensions; and
generating an abnormality detection model used to infer a state of the inspection target by executing training using the first features of the selected k dimensions among the first features of the n-dimensions of the training image.
